(19) United States
(12) Patent Application Publication
(10) Pub. No.: US 2003/0212350 A1
(43) Pub. Date: Nov. 13, 2003

(54) Apparatus and method for treating scar tissue

(76) Inventor: Mark Tadlock, Tucson, AZ (US)

Correspondence Address: Mark E. Ogram, 7454 E. Broadway ste 203, Tucson, AZ, 85710, US

(21) Appl. No.: 10/144,417

(22) Filed: May 13, 2002

(51) Int. Cl. A61H 1/00; A61H 1/02; A61H 5/00; A61H 7/00

(52) U.S. Cl. 601/2; 601/6

(57) ABSTRACT

A method and kit for the treatment of scar tissue in which the epidermis is raised from the scared area using a suction amount defined by the patient's epidermis. Using a gauge mounted on the manual pump, the operator is able to apply as much or as little suction to accomplish the task of treating the scar tissue, without running the risk of further damaging the site from excessive suction. While the epidermis is raised, manual manipulation or sonic vibrations are used to, disrupt the fibrous tissue of the scar.

### BACKGROUND OF THE INVENTION

This invention relates generally to rehabilitation treatments and apparatus and more particularly to apparatus and methods for reducing scar tissue.

The initial stages of healing are the same for all parts of the body. After injury, the blood clots in the damaged areas of tissue, and white blood cells and various chemicals (including histamine, enzymes, and proteins from which new cells are made) accumulate at the site of the damage. Fibrous tissue is laid down within the blood clot to form a supportive structure.

In some cases, the cells are unable to proliferate or there may be an inadequate blood supply or persistent infection that prevents tissue regeneration. If this case, the fibrous tissue that forms in the blood clot develops into tough scar tissue that keeps the tissue structure intact. This tough scar tissue often causes a restriction of movement at the affected site.

When this occurs, there is a need to “break” the fibrous tissue so that the body can absorb it and re-introduce a higher freedom of movement.

A variety of techniques have been developed to assist in the breaking of the fibrous tissue. These include: adding heat the site to increase blood flow; and, the application of ultrasonic vibrations to the site.

The most reliable technique though is a massaging of the scar tissue. To assist in the treatment, a suction is placed over the scared area to pull the epidermis away from the underlying tissue, thereby exposing the scar tissue to more intense manipulation.

The application of suction is typically done using a syringe-type implement with a circular mouth. After placing the mouth over the scar, the operator fully depresses the plunger to cause the suction.

The epidermis of people differ dramatically due to age, environment, and health. Applying a “one suction fits all” approach will usually either damage (when the epidermis is friable) or be insufficient (where the epidermis is thick or calloused). In the first case, the treatment can do more damage than good; in the second, the treatment is less than effective.

It is clear from the forgoing that there is a significant need for an efficient apparatus and method for reducing scar tissue.

### SUMMARY OF THE INVENTION

The invention is a method and kit for the treatment of scar tissue. While the present discussion relates to the treatment of scars on humans, the invention is not so limited and those of ordinary skill in the art readily recognize that the present invention is also useful for the treatment of scars in a variety of animals, including, but not limited to: dogs, race horses, and cats.

Within the present invention, the epidermis is raised from the scared area using suction. The amount of suction which is applied is defined by the individual's epidermis condition. Because the treatment of scar tissue usually requires a series of visits and treatment, the health care provider is able to select a lower amount of suction initially and then raise it, noting if any collateral damage is done; if not, the level of suction applied is increased for subsequent treatments; if there is collateral damage, then the level of suction is decreased for later treatments.

Because the suction level being applied is identified, the health care provider is able to make accurate notes and comments regarding the affect of the treatment at specified suction amounts; thereby allowing the treatment to be “tailored” for the particular patient.

In other embodiments of the invention, a reference table is used for the selection of the suction amount. This reference table is defined from experience and extends from tissue which is very friable to tissue which is extremely durable. The health care provider accesses the treatment site and, with the help of the table, selects the appropriate suction amount.

The identification of the suction amount is established using a gauge mounted onto a manual pump. As the operator increases the suction, an immediate and accurate reading is provided by the gauge. In this way, the operator is able to apply as much or as little suction to accomplish the task of treating the scar tissue, without running the risk of further damaging the site from excessive suction.

In the preferred embodiment of the invention, the meter is mounted onto the hand-held pump. This allows the operator to control the operation of the pump and align the meter for easy monitoring using only a single hand.

While the epidermis is raised, the fibrous tissue within the scar is “broken” or disrupted; thereby allowing the fibrous tissue to be absorbed into the body naturally. In the preferred embodiment manual manipulation is used in this context.

In an alternative embodiment, sonic vibrations are used to disrupt the fibrous tissue of the scar. While this is typically done using a separate instrument, one embodiment provides for the sonic vibrations to be emitted through the suction mouth (connected to the patient). This embodiment of the invention allows the health care provider to raise the epidermis using the suction, activate the sonic vibrations, and allow the instrument to operate for a set period of time.

The invention, together with various embodiments thereof, will be more fully explained by the accompanying drawings and the following descriptions thereof.

### DRAWINGS IN BRIEF

FIG. 1 is a perspective view of the preferred embodiment of the invention.

FIGS. 2A and 2B illustrate the raising of the epidermis.

FIG. 3 is a side view of a suction applicator having a built-in ultrasonic generator.

FIGS. 4A and 4B illustrate two alternative suction applicators.

FIGS. 5A, 5B, 5C, 5D, 5E, and 5F illustrate the preferred steps in treating scar tissue.

### DRAWINGS IN DETAIL

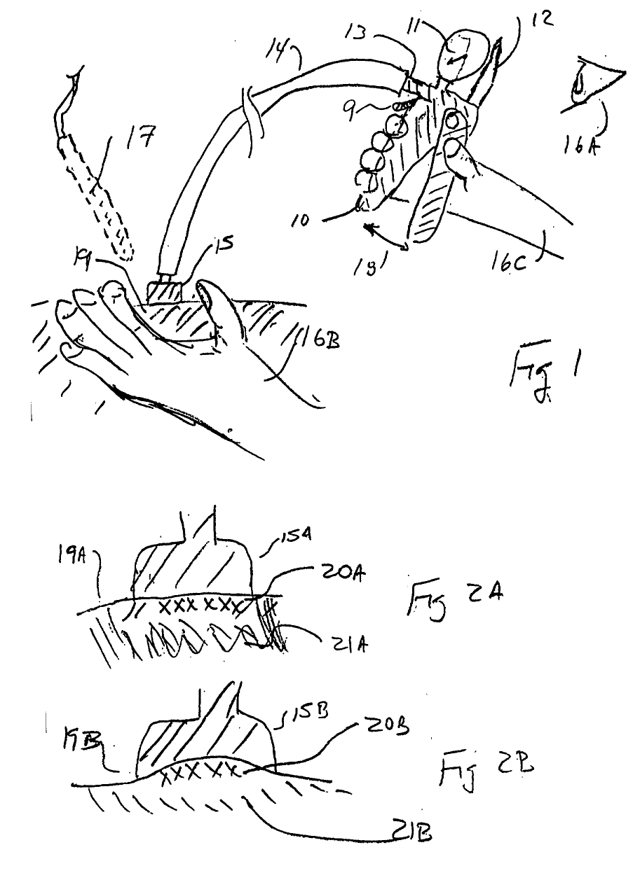

FIG. 1 is a perspective view of the preferred embodiment of the invention.

Hand pump 10 is operated by manual pressure 18 moving the handle as indicated by operator 16C. Prior to the application of the suction, operator 16A reviews table 12 to determine the proper level of suction to apply to treatment site 19. The suction level is monitored using gauge 11 by operator 16A

Suction is applied through inlet port 13 which is attached to flexible tubing 14 having a suction applicator 15 thereon. Suction applicator 15 surrounds treatment site 19.

When the appropriate level of suction has been applied, in the preferred embodiment, operator 16B manually massages treatment site 19 to “break” the scar tissue for re-absorption into the patient's body. In an alternative embodiment, ultrasonic vibrations are generated by ultrasonic probe 17 to “break” the scar tissue.

In this manner, operator 16 is able to select the appropriate suction level, apply that level of suction accurately, and then apply the treatment to the site to break the scar tissue. When the treatment is completed, operator 16C depresses release 9 to eliminate the suction being applied.

FIGS. 2A and 2B illustrate the raising of the epidermis.

Referring to FIG. 2A, when suction applicator 15A has been placed over scar tissue 20A at treatment site 19A, suction is applied. Below scar tissue 20A is normal tissue 21A.

After suction has been applied, FIG. 2B, at the treatment site 19B, the upper layer of epidermis is pulled upward, thereby partially separating scar tissue 20B from the underlying healthy tissue 21B. This movement of scar tissue 20B allows for the subsequent massaging or vibrations to have a more effective affect upon the scar tissue.

FIG. 3 is a side view of a suction applicator having a built-in ultrasonic generator.

In this embodiment of the invention, suction applicator 30, is used in a similar manner as described above. In this embodiment, suction applicator 30 has incorporated into it ultrasonic vibrator 31 (encircling the rim of the suction applicator 30). Power is delivered by wire 32.

After suction is applied to the treatment site via suction, applicator 30, ultrasonic vibrator 31 is activated; thereby providing a highly localized treatment of the scar tissue. A timer, not shown, is used to provide the ultrasonic vibrations for a period of time before the time deactivates ultrasonic vibrator 31.

This embodiment is useful for extended treatments and also for home treatment of scar tissue.

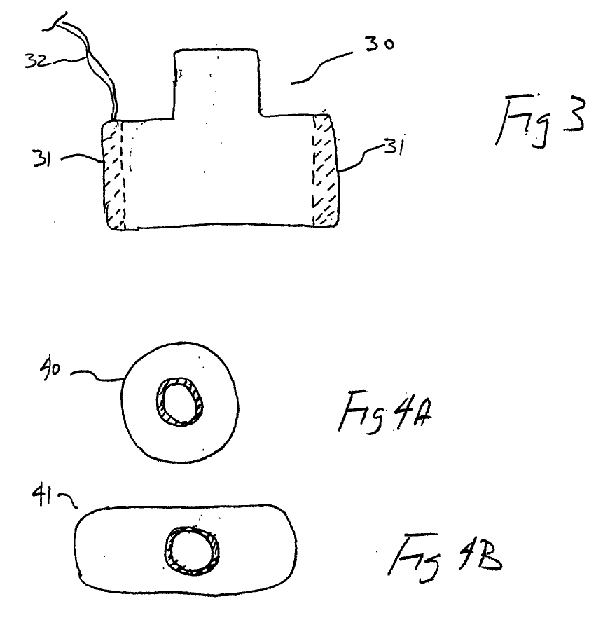

FIGS. 4A and 4B illustrate two alternative suction applicator.

While these drawings are top views of two embodiments of the suction applicator, those of ordinary skill in the art readily recognize a variety of shapes which can be employed.

The preferred suction applicator 40 (FIG. 4A) is round. An alternative shape for the suction applicator 41 is more oval (FIG. 4B) which is more suited for an elongated scar.

In both cases shown, the variety of sizes and shapes allows the operator to choose the size and shape best able to address the scar requiring the treatment.

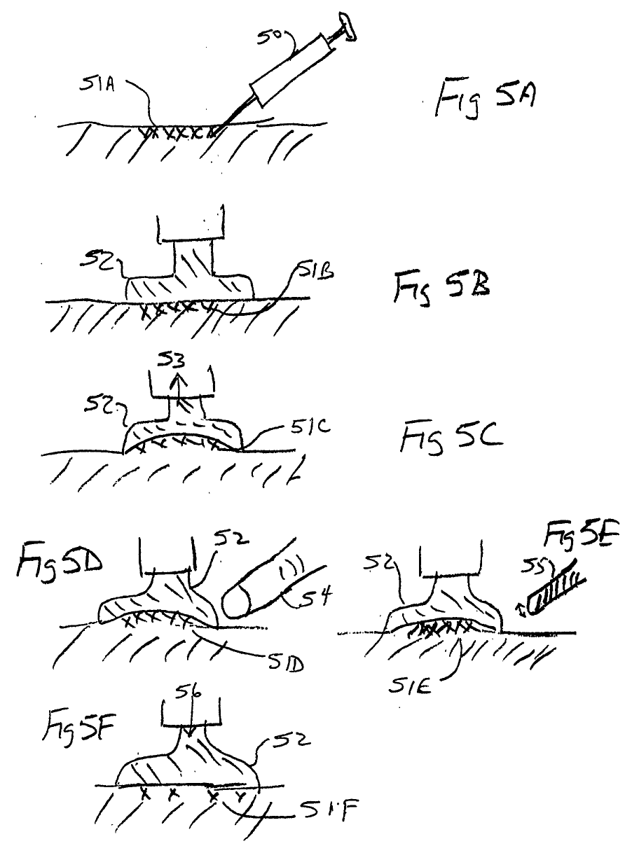

FIGS. 5A, 5B, 5C, 5D, 5E, and 5F illustrate the preferred steps in treating scar tissue.

Referring to FIG. 5A, scar tissue 51 is first treated with a local anaesthetic and relaxing agent 50. While this figure illustrates the injection of these drugs in other embodiments, a topical cream is used for the same purpose. While this step is optional, in certain situations, the application of a relaxing agent is highly beneficial to the overall outcome and patient comfort.

Suction applicator 52 is placed over scar tissue 51B, as shown in FIG. 5B. The shape of suction applicator 52 is chosen to fully encircle scar tissue 51B.

After having identified the amount of suction to apply, as shown in FIG. 5C, suction 53 is applied to the scar tissue 51C to lift and separate it partially from the underlying tissue. This action pulls scar tissue 51B partially within suction applicator 52.

The preferred method of disrupting the underlying scar tissue is shown in FIG. 5D. With scar tissue 51D pulled within suction applicator 52, manual massage 54 is applied to scar tissue 51D.

The alternative method for disrupting scar tissue 5E (FIG. 5E). Ultrasonic vibrator 55 is applied to the site to break apart the scar's supportive structure.

Once the massage or ultrasonic is completed, as shown in FIG. 5F, the suction is eliminated 56, thereby allowing scar tissue 51F to relax into its natural state.

It is clear that the present invention provides for a highly improved apparatus and method for reducing scar tissue.

What is claimed is:

1. A method of treating scar tissue comprising the steps of:
a) identifying a selected suction amount;
b) raising the epidermis of a treatment site by applying suction at the selected level;
c) while said epidermis is raised, disrupting fibrous tissue within said selected site while said epidermis is raised; and,
d) eliminating suction from the treatment site.

2. The method of treating scar tissue according to claim 1, wherein the step of disrupting fibrous tissue within said selected site includes the step of applying ultrasonic vibrations to the selected site.

3. The method of treating scar tissue according to claim 2, further including the step of applying a relaxing agent to the treatment prior to the step of raising the epidermis.

4. The method of treating scar tissue according to claim 1, wherein the step of disrupting fibrous tissue within said selected site includes the step of manually massaging the treatment site.

5. The method of treating scar tissue according to claim 4, further including the step of monitoring an actual suction level until the selected suction level is obtained.

6. The method of treating scar tissue according to claim 5,
a) wherein the step of identifying a selected suction level includes the step of accessing an epidermis condition at the treatment site; and,
b) wherein the step of raising the epidermis includes the step of monitoring epidermis conditions around the treatment site.

7. The method of treating scar tissue according to claim 3, further including the step of terminating application of suction should the step of monitoring epidermis conditions around the treatment site indicate a damaging of the epidermis around the treatment site.

8. The method of treating scar tissue according to claim 7, prior to the step of applying suction, selecting a suction applicator sufficiently large enough to encompass the entire surgical site.

9. A treatment method for scar tissue comprising the steps of:
a) raising the epidermis of a treatment site by applying suction at an amount defined by a condition of the treatment site;
b) while said epidermis is raised, disrupting fibrous tissue within said selected site while said epidermis is raised.

10. The treatment method according to claim 9, further including the step of at the time of treatment, identifying a selected suction amount prior to the step of raising the epidermis.

11. The treatment method according to claim 10, wherein the step of disrupting fibrous tissue within said selected site includes the step of applying ultrasonic vibrations to the selected site.

12. The treatment method according to claim 11, further including the step of applying a relaxing agent to the treatment prior to the step of raising the epidermis.

13. The treatment method according to claim 9, wherein the step of disrupting fibrous tissue within said selected site includes the step of manually massaging the treatment site.

14. The treatment method according to claim 13, further including the step of monitoring an actual suction level until the selected suction level is obtained.

15. The treatment method according to claim 14,
a) wherein the step of identifying a selected suction level includes the step of accessing an epidermis condition at the treatment site; and,
b) wherein the step of raising the epidermis includes the step of monitoring epidermis conditions around the treatment site.

16. The treatment method according to claim 14, further including the step of terminating application of suction should the step of monitoring epidermis conditions around the treatment site indicate a damaging of the epidermis around the treatment site.

17. The treatment method according to claim 16, prior to the step of applying suction, selecting a suction applicator sufficiently large enough to encompass the entire surgical site.

18. A kit adapted to assist in the treatment of scar tissue comprising:
a) a handle assembly having,
1) a manually operable pump configured to withdraw atmosphere through an input port,
2) a gauge communicating with said input port, said gauge providing visual readings of an amount of suction within said input port, and,
3) release means for venting atmosphere into said input port;
b) a flexible tubing, a first end thereof connectable to said input port; and,
c) a suction applicator configured to encircle a treatment site, said suction applicator connectable to a second end of said flexible tubing.

19. The kit according to claim 18, further including at least two additional suction applicators, each of said two additional suction applicators having different shapes.

20. The kit according to claim 18, further including at least two additional suction applicators, each of said two additional suction applicators having different mouth sizes.
